(19) United States
(12) Patent Application Publication
(10) Pub. No.: US 2024/0387812 A1
(43) Pub. Date: Nov. 21, 2024

(54) Disordered Rock-Salt Cathode Materials with Lithiated Spinel Character

(71) Applicant: UCHICAGO ARGONNE, LLC, Chicago, IL (US)

(72) Inventors: Michael M. THACKERAY, Naperville, IL (US); Eungje LEE, Naperville, IL (US); Boyu SHI, Willowbrook, IL (US); Jason R. CROY, Plainfield, IL (US)

(21) Appl. No.: 18/408,979

(22) Filed: Jan. 10, 2024

Related U.S. Application Data
(60) Provisional application No. 63/438,725, filed on Jan. 12, 2023.

(51) Int. Cl. H01M 4/505; H01M 4/02; H01M 4/525; H01M 10/0525

(52) U.S. Cl. CPC H01M 4/505; H01M 4/525; H01M 10/0525; H01M 2004/028

(57) ABSTRACT

Electrode active materials with lithiated spinel character are described herein. An electrode active material having the general empirical formula Li₂Ni_{2-x-y}MnₓM′_{y}O₄ (Formula I); wherein M′ comprises ions of one or more metal other than Ni and Mn; 0<x≤0.66; 0≤y≤0.25; 0<(x+y)<1; and the material has a Ni:Mn molar ratio that is greater than 2:1. Electrochemical cells and batteries comprising the materials of Formula I also are described herein.

### CROSS-REFERENCE TO RELATED APPLICATIONS

This application claims the benefit of U.S. Provisional Application Ser. No. 63/438,725, filed on Jan. 12, 2023, which is incorporated herein by reference in its entirety.

### STATEMENT OF GOVERNMENT INTEREST

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to electrode materials for rechargeable lithium-based cells and battery systems.

### BACKGROUND OF THE INVENTION

Li-ion battery technology has been successfully used by portable electronic devices. However, mass adoption for transportation and electric grid storage has been limited by the commercial availability of scarce resources and production. The biggest cost driver of Li-ion batteries is the positive electrode (cathode). The most common cathode material is LiCoO₂ with a NaFeO₂-type layered structure, where Co acts as an electrochemical redox center and Li is the intercalating ion. In addition to layered oxides, spinel and olivine-type cathode materials make up the bulk of commercial utilization and all operate under the same 3d-metal redox couples such as Mn, Fe, Co, and Ni, which have been exhaustively investigated. Current high energy density cathodes are layered oxides using the chemical formula Li(NMC)O₂ in which NMC is a combination of Ni, Mn and Co in relative proportions adding up to 1. These materials are often commonly referred to as NMC materials. The inclusion of excess Li has been one route to increase the capacity of cathode materials, referred to as Li-excess or Li-rich NMCs.

Layered LiNiO₂ and substituted Ni-rich LiNiₓM″′₁₋ₓO₂ NMC materials in which M″′ is Mn and Co, such as LiNi_{0.8}Mn_{0.1}Co_{0.1}O₂ (NMC811) and LiNi_{0.6}Mn_{0.2}Co_{0.2}O₂ (NMC622) are well known in the art and have been commercialized in today's Li-ion batteries, particularly to serve the growing electric vehicle market. NMC materials that contain a lower nickel content, for example LiNi_{0.333}Mn_{0.333}Co_{0.333}O₂ (NMC111), provide lower electrochemical capacity, and hence a lower cell energy relative to their Ni-rich counterparts, as highlighted in recent reviews of Ni-rich NMC materials by Li et al. Electrochem. Energy Rev., 3, 43-80 (2020) and Manthiram et al. Nature Energy, 5, 26-34 (2020).

Unlike the first-row transition metals, such as titanium, vanadium and manganese, that can form a stoichiometric LiB₂O₄ spinel structure, in which B represents one transition metal ion, such as LiTi₂O₄, LiMn₂O₄, LiV₂O₄ and LiCo₂O₄, a pure, single-phase lithium-nickel-oxide LiNi₂O₄ structure is relatively difficult to prepare in practice. In 1985, Thomas et al. Mater. Res. Bull., 20, 1137-1146 (1985) reported that a lithium nickel oxide spinel product with cubic symmetry could be prepared together by extracting lithium electrochemically from a layered Li₁₋ₓNi₁₊ₓO₂ (0.95<(1−x)<1.0) electrode precursor to the composition Li_{0.5}Ni₁₊ₓO₂ and then annealing the delithiated product at 200° C. In 1994, Kanno et al. J. Solid State Chem, 110, 216-225, (1994) prepared a cubic lithium-nickel-oxide that also resembled a spinel-like LiNi₂O₄ product using a similar approach to that described by Thomas et al. Kanno et al. also demonstrated that a lithiated-spinel product, Li₂Ni₂O₄, could be produced by discharging a Li/LiNi₂O₄ cell between 4.1 V and 1.75 V, with corresponding values of about 2.5 and about 1.9 V on open circuit (id.).

Later reports, for example, by Arai et al. Solid State Ionics, 109, 295-302 (1998), Lee et al. J. Electrochem. Soc., 148, A716-A722 (2001), Guilmard et al. Chem. Mater., 15, 4476-4483 (2003) and Ceder et al. Chem. Mater, 19, 543-552 (2007) confirmed these results and highlighted the complexity of the Li—Ni—O system in terms of the thermal, electrochemical, structural and compositional behavior of layered-, spinel- and disordered rock salt components, and that the transition on heating a lithium-deficient layered Li₁₋ₓNiO₂ structure (x approximately 0.5) to a spinel configuration requires the partial migration of nickel ions from the nickel-rich layers to the lithium-rich layers (Cedar et al., id.). In practice, lithium-nickel-oxide spinel structures made by this method are not well ordered, rendering them unattractive as electrodes for lithium battery applications.

Single-phase, nickel-rich LiNi₂O₄ spinel is difficult to make. This difficulty is attributed to the inherent instability of the oxidized nickel ions that are produced by extracting lithium, either chemically or electrochemically, from a layered LiNiO₂ precursor structure (in which there is typically some disorder between the lithium and nickel ions in alternate layers of the close-packed oxygen lattice) and the tendency for the ions to be reduced to a more stable trivalent or divalent state, for example, by the release of oxygen from the particle surface. When nickel and manganese ions exist as nearest neighbors in layered LiMn_{0.5}Ni_{0.5}O₂ and spinel LiMn_{1.5}Ni_{0.5}O₄ structures, these ions typically adopt divalent and tetravalent states, respectively, such that the electrochemical charge and discharge reactions occur predominantly on the divalent nickel ions rather than the tetravalent manganese ions, the latter remaining electrochemically inactive, thereby acting as stabilizing agents for the electrode structure.

There is an ongoing need for alternative nickel-rich spinel-like cathode materials. The cathode material described herein address this need.

### SUMMARY

Nickel-rich and manganese-containing, disordered rock salt lithium metal oxide cathode materials are described herein, which comprise a lithiated spinel structure, or partially disordered variations thereof (referred to herein as having “lithiated spinel character”). The materials have the general formula Li₂Ni_{2-x-y}MnₓM′_{y}O₄ (Formula I) with a Ni:Mn ratio that is greater than 2:1 and where M′ comprises ions of one or more transition metal ions, and/or one or more non-transition metal, in which 0<x≤0.66 and 0≤y≤0.25, preferably 0<x<0.5 and 0≤y≤0.1, such that 0<(x+y)<1. In some embodiments, the materials of Formula I (Li₂Ni_{2-x-y}MnₓM′_{y}O₄) can comprise structurally-intergrown Ni-rich components consisting of partially-disordered lithiated spinel components, partially-disordered layered components and, optionally, more extensively disordered rock-salt components.

The materials of Formula I are typically prepared at a moderately low temperature (LT), typically between 40° and 650° C., and can be used to stabilize (e.g., by structural integration) high capacity, lithium- and manganese-rich lithium metal oxide electrodes with a layered configuration, designated in two component notation as nLi₂MnO₃·(1−n)LiM″O₂, in which M″ is one or more metal ions, at least one of which is manganese, nickel or cobalt.

The following non-limiting embodiments are provided below to illustrate certain aspects and features of the methods described herein.

Embodiment 1 is an electrode active material with lithiated spinel character, and having the general empirical formula Li₂Ni_{2-x-y}MnₓM′_{y}O₄ (Formula I); wherein M′ comprises ions of one or more metal other than Ni and Mn; 0<x≤0.66; 0≤y≤0.25; 0<(x+y)<1; and the material has a Ni:Mn molar ratio that is greater than 2:1.

Embodiment 2 is the electrode active material of embodiment 1, wherein M′ comprises ions of one or more of transition metal.

Embodiment 3 is the electrode active material of embodiment 1 or embodiment 2, wherein the transition metal is selected from the group consisting of Co, Ti, V, Fe, Cu and Zr.

Embodiment 4 is the electrode active material of any one of embodiments 1 to 3, wherein M′ comprises ions of one or more non-transition metal.

Embodiment 5 is the electrode active material of embodiment 4, wherein the non-transition metal is selected from the group consisting of Al and Mg.

Embodiment 6 is the electrode active material of any one of embodiments 1 to 5, wherein M′ comprises ions of one or more non-transition metal and one or more transition metal.

Embodiment 7 is the electrode active material of any one of embodiments 1 to 6, wherein M′ comprises Co.

Embodiment 8 is the electrode active material of any one of embodiments 1 to 7, wherein M′ comprises Al.

Embodiment 9 is the electrode active material of any one of embodiments 1 to 8, wherein M′ comprises Co and Al.

Embodiment 10 is the electrode active material of any one of embodiments 1 to 9, wherein 0<x<0.5.

Embodiment 11 is the electrode active material of any one of embodiments 1 to 10, wherein 0<y≤0.1.

Embodiment 12 is the electrode active material of any one of embodiments 1 to 11, wherein 0<x<0.5 and 0<y≤0.1.

Embodiment 13 is the electrode active material of any one of embodiments 1 to 12, wherein the Ni:Mn molar ratio is in the range of about 2.01:1 to about 18:1.

Embodiment 14 is the electrode active material of any one of embodiments 1 to 13, wherein the Ni:Mn molar ratio is about 2.5:1 or greater.

Embodiment 15 is the electrode active material of any one of embodiments 1 to 14, wherein the Ni:Mn molar ratio is about 5:1 or greater.

Embodiment 16 is the electrode active material of any one of embodiments 1 to 15 structurally integrated with a layered-layered lithium metal oxide of general formula nLi₂MnO₃·(1−n)LiM″O₂; wherein M″ comprises ions of one or more metal, at least one of which is selected from the group consisting of Mn, Ni, and Co; and 0<n<1.

Embodiment 17 is the electrode active material of any one of embodiments 1 to 16, wherein up to 5 mol % of the oxygen thereof is replaced by fluorine.

Embodiment 18 is the electrode active material of any one of embodiments 1 to 17, wherein the metal ions of the material of Formula I are partially disordered relative to an ideal lithiated spinel structure.

Embodiment 19 is the electrode active material of any one of embodiments 1 to 18, wherein the material comprises structurally-intergrown Ni-rich components consisting of partially-disordered lithiated spinel components, partially-disordered layered components and, optionally, more extensively disordered rock-salt components.

Embodiment 20 is an electrochemical cell comprising an anode, a cathode, and a lithium-containing electrolyte contacting the anode and cathode, wherein the cathode comprises the electrode active material of any one of embodiments 1 to 19.

Embodiment 21 is a battery comprising a plurality of the electrochemical cell of embodiment 20 electrically connected in series, in parallel, or in both series and parallel.

The electrode materials described herein provide a new compositional range of Ni-rich, lithium-metal-oxide cathodes for Li-ion batteries consisting of partially-disordered, lithiated-spinel components with 3-dimensional channels for Li⁺-ion conduction, structurally-integrated with partially-disordered layered components with 2-dimensional pathways for Li⁺ ions, and more extensively-disordered rock salt components that act predominantly as stabilizing agents for the electrode structure overall.

### BRIEF DESCRIPTION OF THE DRAWINGS

FIG. 1 depicts a powder XRD pattern of Li₂Ni_{1.44}Mn_{0.56}O₄ (Ni:Mn=2.57:1), alongside the patterns of 4 other compositions, for comparison, with formulae Li₂Ni_{1.20}Mn_{0.80}O₄ (Ni:Mn=1.5:1), Li₂NiMnO₄ (Ni:Mn=1:1), Li₂Ni_{0.82}Mn_{1.18}O₄ (Ni:Mn=0.69:1) and Li₂Ni_{0.68}Mn_{1.32}O₄ (Ni:Mn=0.51:1), which have lithiated spinel-like and 10 disordered-layered-type character.

FIG. 2A depicts electrochemical profiles of a Li/Li₂Ni_{1.44}Mn_{0.56}O₄ cell for the initial, second and fifth cycles.

FIG. 2B depicts the corresponding dQ/dV plots for a Li/Li₂Ni_{1.44}Mn_{0.56}O₄ cell.

FIG. 3 depicts plots of charge and discharge specific capacity versus cycle number for a Li/Li₂Ni_{1.44}Mn_{0.56}O₄ cell.

FIG. 4 depicts a schematic representation of an electrochemical cell.

FIG. 5 depicts a schematic representation of a battery consisting of a plurality of cells connected electrically in series and in parallel.

### DETAILED DESCRIPTION

Novel, nickel-rich and manganese-containing disordered rock salt oxide materials having lithiated spinel character are described herein. The materials are defined by the general empirical formula Li₂Ni_{2-x-y}MnₓM′_{y}O₄ (Formula I) in which M′ comprises one or more metal ions other than Ni and Mn, such as non-transition metal ions (e.g., aluminum and magnesium ions), and/or one or more transition metal ions (e.g., cobalt, titanium, vanadium, iron, copper and zirconium ions), wherein 0<x≤0.66; 0≤y≤0.25; 0<(x+y)<1 and the material has a Ni:Mn molar ratio that is greater than 2:1. In some embodiments, 0<x<0.5. In some other embodiments, 0<y≤0.1. In yet other embodiments, 0<x<0.5 and 0<y≤0.1. The materials comprise a lithiated spinel crystal structure or a partially disordered lithiated spinel structure in which there is some degree of disorder or mixing of the lithium ions and other metal ions within the crystal matrix.

As used herein, the term “rock salt” refers to a cation-to anion stoichiometry of a lithium metal oxide material in which there is a 1:1 ratio of cations to anions (i.e., a 1:1 ratio of metal ions (Li plus other metal ions) to oxygen) as in sodium chloride, NaCl. For this invention, “disordered rock salt” refers to Li₂Ni_{2-x-y}MnₓM′_{y}O₄ materials (Formula I) with a rock salt stoichiometry and structure in which the cations are partially disordered relative to to an ideal rock salt structure in which the cations are uniformly and homogeneously distributed within the structure.

The materials of Formula I can be prepared by reacting lithium, manganese and nickel precursor salts, such as hydroxides, carbonates, sulfates and nitrates that decompose and react with one another at about 200 to 650° C., preferably between 40° and 650° C., although higher temperatures may be needed for some material compositions, e.g., to form anhydrous products, to achieve the desired material composition, to achieve a desired crystal structure, and the like. The materials of Formula I described herein are typically prepared at a moderate 15 temperature, for example, between about 300 and about 650° C., preferably between about 400 and about 500° C.

The materials of Formula I have composite structures with regions of partially-disordered lithiated-spinel-type configurations that are structurally-integrated with regions of partially disordered layered configurations and, to a lesser extent, regions of more extensively disordered rock salt configurations. The materials may contain cation and/or anion vacancies, such that the composition of the rock salt components varies from the 1:1 cation:anion ratio in an ideal rock salt structure. Optionally, some of the oxygen in Formula I can be replaced by fluoride ions, either in the bulk of the lithiated spinel electrode structure or at the surface, or both, if desired, e.g., to increase operating voltage and/or cycling stability. Preferably, less than 5 percent of the oxygen ions in the electrode materials of Formula I are replaced by fluoride ions.

As noted above, the difficulty in making a single-phase, nickel-rich LiNi₂O₄ spinel product is attributed to the inherent instability of the oxidized nickel ions that are produced by extracting lithium, either chemically or electrochemically, from a layered LiNiO₂ precursor structure, and the tendency for the ions to be reduced to a more stable trivalent or divalent state, for example, by the release of oxygen from the particle surface. In contrast, the nickel-rich lithium metal oxide materials of Formula I comprise a lithiated spinel configuration, stabilized with relatively small amounts of manganese, optionally in the presence of other stabilizing cations such as trivalent aluminum ions.

The materials of Formula I have the general formula Li₂Ni_{2-x-y}MnₓM′_{y}O₄, wherein M′ comprises one or more metal ions other than Ni and Mn, such as non-transition metal ions (e.g., aluminum and magnesium ions), and/or one or more transition metal ions (e.g., cobalt, titanium, vanadium, iron, copper and zirconium ions), wherein 0<x≤0.66; 0≤y≤0.25; 0<(x+y)<1 and the material has a Ni:Mn molar ratio that is greater than 2:1; for example Li₂Ni_{1.5}Mn_{0.5}O₄ (x=0.5, y=0; Ni:Mn=3:1), and Li₂Ni_{1.5}Mn_{0.45}Al_{0.05}O₄ (x=0.45, y=0.05, Ni:Mn=3.33). In some embodiments, the Ni:Mn ratio is about 2.01:1 to about 18:1 (e.g., 2.01:1 to about 9:1; 2.5:1 or greater; 5:1 or greater). These electrode materials can be used on their own or, alternatively, as integrated components to stabilize layered lithium-metal-oxide electrode structures, notably Li- and Mn-rich composite electrodes that can be designated in two-component notation as nLi₂MnO₃·(1−n)LiM″O₂ (Formula II) in which M″ is one or more metal cations comprising at least one metal selected from Mn, Ni and Co, and 0<n<1. It should be noted that stabilized electrode materials comprising an integrated structure with components of both Formula I and Formula II may have to be synthesized at higher temperatures than the Li₂Ni_{2-x-y}MnₓM′_{y}O₄ materials of Formula I alone, for example, between 65° and 800° C., or higher if necessary.

The materials of Formula I are typically prepared at a moderately low temperature (LT), typically between 40° and 650° C., and can be used to stabilize (e.g., by structural integration) high capacity, lithium- and manganese-rich lithium metal oxide electrodes with a layered configuration, designated in two component notation as nLi₂MnO₃·(1−n)LiM″O₂, in which M″ is one or more metal ions, at least one of which is manganese, nickel or cobalt.

In some embodiments, M′ comprises ions of one or more transition metal ions, such as Co, Ti, V, Fe, Cu and Zr ions. Optionally, M′ can also comprise one or more non-transition metal ions such as Al and Mg in addition to the transition metal. In some embodiments, M′ comprises Co; in other embodiments, M′ comprises Al; and in yet other embodiments, M′ comprises Co and Al.

In some embodiments, the electrode active material of Formula I is structurally integrated with a layered-layered lithium metal oxide of general formula nLi₂MnO₃·(1−n)LiM″O₂; wherein M″ comprises ions of one or more metal, at least one of which is selected from the group consisting of Mn, Ni, and Co; and 0<n<1; wherein optionally, up to 5 mol % of the oxygen thereof is replaced by fluorine. The materials of Formula I and structurally-integrated composites thereof are partially disordered relative to an ideal lithiated spinel structure and to an ideal layered structure. In some embodiments, the electrode active material of Formula I and/or the structurally-integrated composites thereof can comprise structurally-intergrown Ni-rich components consisting of partially-disordered lithiated spinel components, partially-disordered layered components and, optionally, more extensively disordered rock-salt components.

Non-limiting examples of the materials of Formula I include compositions such as Li₂Ni_{1.34}Mn_{0.66}O₄, Li₂Ni_{1.44}Mn_{0.56}O₄, and Li₂Ni_{1.5}Mn_{0.5}O₄, in which the Ni:Mn ratio is 2.03:1, 2.57:1, and 3.0:1, respectively, and substituted materials such as Li₂Ni_{1.33}Mn_{0.60}Al_{0.07}O₄ and Li₂Ni_{1.5}Mn_{0.45}Al_{0.05}O₄, in which Mn is partially substituted by Al thereby yielding a Ni:Mn ratio of 2.22. The materials of Formula I also include compositions with lower values of x, i.e., with a lower Mn content, for example with a Ni:Mn ratio between Li₂Ni_{1.5}Mn_{0.5}O₄ (3:1) and Li₂Ni_{1.75}Mn_{0.25}O₄ (Ni:Mn=7.5:1) or higher, as well as substituted compositions such as Li₂Ni_{1.73}Mn_{0.25}Al_{0.02}O₄ (Ni:Mn=6.92:1) and Li₂Ni_{1.75}Mn_{0.20}Co_{0.05}O₄ (Ni:Mn=8.75).

In some embodiments, the materials of Formula I are cobalt-free. Such Co-free materials are particularly attractive as they are less expensive than lithium-metal-oxide cathode materials containing cobalt.

Electrodes comprising the materials of Formula I can be prepared by techniques that are well known in the battery trade. An intercalation electrode composition can comprise, for example, at least about 55% by weight of the material of Formula I, at least about 5% by weight carbon, and at least about 5% by weight of a binder such as polyvinylidene difluoride (PVDF). For example, the intercalation electrode composition can comprise about 85% by weight of the material of Formula I, about 5% by weight carbon, and about 10% by weight binder. As another example, the intercalation electrode composition may comprise about 75% by weight of the material of Formula I, about 15% by weight carbon, and about 10% by weight of the binder. Non-limiting examples of the carbon material include, for example, conductive carbon black (e.g., TIMCAL SUPER C45 or TIMCAL SUPER P), graphene, graphene nanoplatelets, and acetylene black.

As used herein the term “lithium-ion battery” refers to electrochemical cells and combinations of electrochemical cells in which lithium (e.g., lithium ion) shuttles between an anode (e.g., a carbon-based anode) and a cathode, and includes so-called full cells, as well as so-called half-cells (i.e., cells comprising a lithium metal anode).

As used herein, the terms “structurally-integrated”, “structurally-integrated composite”, and “structurally intergrown” when used in relation to a lithium metal oxide a material refers to materials that include domains (e.g., locally ordered, nano-sized or micro-sized domains) indicative of different metal oxide compositions having different crystalline forms (e.g., layered or spinel forms) within a single particle of the composite metal oxide, in which the domains share substantially the same oxygen lattice and differ from each other by the elemental and spatial distribution of metal ions in the overall metal oxide structure. Structurally-integrated composite lithium metal oxides are different from and generally have different properties than mere mixtures or combinations of two or more metal oxide components (for example, mere mixtures do not share a common oxygen lattice).

Electrodes for lithium electrochemical cells typically are formed by coating a slurry of electrode active material in a solvent (e.g., a polar aprotic solvent such as N-methyl pyrrolidinone) with a polymeric binder (e.g., poly(vinylidene difluoride); PVDF) onto a current collector (e.g., metal foil, conductive carbon fiber paper, and the like), and drying the coating to form the electrode. Some examples of electrode active materials can be found, e.g., in Mekonnen, Y., Sundararajan, A. & Sarwat, A. I. “A review of cathode and anode materials for lithium-ion batteries,” Southeast Con 2016, Norfolk, VA, pp. 1-6, (2016), which is incorporated herein by reference in its entirety.

The electrodes utilize binders (e.g., polymeric binders) to aid in adhering cathode active materials to the current collectors. In some cases, the binder comprises a poly(carboxylic acid) or a salt thereof (e.g., a lithium salt), which can be any poly(carboxylic acid), such as poly(acrylic acid) (PAA), poly(methacrylic acid), alginic acid, carboxymethylcellulose (CMC), poly(aspartic acid) (PAsp), poly(glutamic acid) (PGlu), copolymers comprising poly(acrylic acid) chains, poly(4-vinylbenzoic acid) (PV4BA), and the like, which is soluble in the electrode slurry solvent system. The poly(carboxylic acid) can have a Mn, as determined by GPC, in the range of about 1000 to about 450,000 Daltons (preferably about 50,000 to about 450,000 Daltons, e.g., about 130,000 Daltons). In some other embodiments, the binder may comprise anionic materials or neutral materials such as fluorinated polymer such as poly(vinylidene difluoride) (PVDF), carboxymethylcellulose (CMC), and the like.

Lithium-ion electrochemical cells described herein comprise a cathode (positive electrode comprising the cathode materials of Formula I), an anode (negative electrode), and an ion-conductive separator between the cathode and anode, with the electrolyte in contact with both the anode and cathode, as is well known in the battery art. It is well understood that the function of a given electrode switches from being a positive or negative electrode depending on whether the electrochemical cell is discharging or charging. Nonetheless, for the sake of convenient identification, the terms “cathode” and “anode” as used herein are applied as identifiers for a particular electrode based only on its function during discharge of the electrochemical cell.

Cathodes typically are formed by combining a powdered mixture of the active material and some form of carbon (e.g., carbon black, graphite, or activated carbon) with a binder such as (polyvinylidene difluoride (PVDF), carboxymethylcellulose, and the like) in a solvent (e.g., N-methyl pyrrolidinone (NMP) or water) and the resulting mixture is coated on a conductive current collector (e.g., aluminum foil) and dried to remove solvent and form an active layer on the current collector.

The anode comprises a material capable of reversibly releasing and accepting lithium during discharging and charging of the electrochemical cell, respectively. Typically, the anode comprises a carbon material such as graphite, graphene, carbon nanotubes, carbon nanofibers, and the like, a silicon-based material such as silicon metal particles, a lead-based material such as metallic lead, a nitride, a silicide, a phosphide, an alloy, an intermetallic compound, a transition metal oxide, and the like. The anode active components typically are mixed with a binder such as (polyvinylidene difluoride (PVDF), carboxymethyl cellulose, and the like) in a solvent (e.g., NMP or water) and the resulting mixture is coated on a conductive current collector (e.g., copper foil) and dried to remove solvent and form an active layer on the current collector.

In electrochemical cell and battery embodiments described herein, the electrolyte comprises an electrolyte salt (e.g., an electrochemically stable lithium salt or a sodium salt) dissolved in a non-aqueous solvent. Any lithium electrolyte salt can be utilized in the electrolyte compositions for lithium electrochemical cells and batteries described herein, such as the salts described in Jow et al. (Eds.), Electrolytes for Lithium and Lithium-ion Batteries; Chapter 1, pp. 1-92; Springer; New York, NY (2014), which is incorporated herein by reference in its entirety.

Non-limiting examples of lithium salts include, e.g., lithium bis(trifluoromethanesulfonyl) imidate (LiTFSI), lithium 2-trifluoromethyl-4,5-dicyanoimidazolate (LiTDI), lithium 4,5-dicyano-1,2,3-triazolate (LiDCTA), lithium trifluoromethanesulfonate (LiTf), lithium perchlorate (LiClO₄), lithium bis(oxalato) borate (LiB(C₂O₄)₂ or “LiBOB”), lithium difluoro (oxalato) borate (LiF₂BC₂O₄ or “LiDFOB”), lithium tetrafluoroborate (LiBF₄), lithium hexafluorophosphate (LiPF₆), lithium hexafluoroarsenate (LiAsF₆), lithium thiocyanate (LiSCN), lithium bis(fluorosulfonyl) imidate (LiFSI), lithium bis(pentafluoroethylsulfonyl) imidate (LiBETI), lithium tetracyanoborate (LiB(CN)₄), lithium nitrate, combinations of two or more thereof, and the like. The lithium salt can be present in the electrolyte solvent at any concentration suitable for lithium battery applications, which concentrations are well known in the secondary battery art. In some embodiments, the lithium salt is present in the electrolyte at a concentration in the range of about 0.1 M to about 5 M, e.g., about 0.5 M to 2 M, or 1 M to 1.5 M. A preferred lithium salt is LiPF₆.

The non-aqueous solvent for the electrolyte compositions include the solvents described in Jow et al. (Eds.), Electrolytes for Lithium and Lithium-ion Batteries; Chapter 2, pp. 93-166; Springer; New York, NY (2014), which is incorporated herein by reference in its entirety. Non-limiting examples of solvents for use in the electrolytes include, e.g., an ether, a carbonate ester (e.g., a dialkyl carbonate or a cyclic alkylene carbonate), a nitrile, a sulfoxide, a sulfone, a fluoro-substituted linear dialkyl carbonate, a fluoro-substituted cyclic alkylene carbonate, a fluoro-substituted sulfolane, and a fluoro-substituted sulfone. For example, the solvent can comprise an ether (e.g., glyme or diglyme), a linear dialkyl carbonate (e.g., dimethyl carbonate (DMC), diethyl carbonate (DEC), ethyl methyl carbonate (EMC) and the like), a cyclic alkylene carbonate (ethylene carbonate (EC), propylene carbonate (PC) and the like), a sulfolane (e.g., sulfolane or an alkyl-substituted sulfolane), a sulfone (e.g., a dialkyl sulfone such as a methyl ethyl sulfone), a fluoro-substituted linear dialkyl carbonate, a fluoro-substituted cyclic alkylene carbonate, a fluoro-substituted sulfolane, and a fluoro-substituted sulfone. The solvent can comprise a single solvent compound or a mixture of two or more solvent compounds.

In some embodiments, the non-aqueous solvent for a lithium electrochemical cell as described herein can be an ionic liquid. Any electrochemically stable ionic liquid solvent can be utilized in the electrolytes described herein, such as the solvents described in Jow et al. (Eds.), Electrolytes for Lithium and Lithium-ion Batteries; Chapter 4, pp. 209-226; Springer; New York, NY (2014), which is incorporated herein by reference in its entirety. In the case of lithium electrochemical cells and batteries, the ionic liquid can optionally include a lithium cation, and can act directly as the electrolyte salt.

The electrolyte compositions for lithium electrochemical cells and batteries described herein also can optionally comprise an additive such as those described in Jow et al. (Eds.), Electrolytes for Lithium and Lithium-ion Batteries; Chapter 3, pp. 167-182; Springer; New York, NY (2014), which is incorporated herein by reference in its entirety. Such additives can provide, e.g., benefits such as SEI, cathode protection, electrolyte salt stabilization, thermal stability, safety enhancement, overpotential protection, corrosion inhibition, and the like. The additive can be present in the electrolyte at any concentration, but in some embodiments is present at a concentration in the range of about 0.0001 M to about 0.5 M. In some embodiments, the additive is present in the electrolyte at a concentration in the range of about 0.001 M to about 0.25 M, or about 0.01 M to about 0.1 M. A commonly used electrolyte composition is 1.2 M LiPF₆ in 3/7 (wt/wt) EC/EMC.

Electrochemical cells typically comprise a cathode, an anode typically comprising carbon, silicon, lead, metallic lithium, some other anode active material, or a combination thereof; and a porous separator between the cathode and anode, with the electrolyte in contact with the anode, the cathode and the separator.

A battery can be formed by electrically connecting two or more such electrochemical cells in series, parallel, or a combination of series and parallel. The electrodes described herein preferably are utilized as the anode in a full-cell configuration in lithium-ion and sodium-ion cells and batteries. Electrochemical cells and battery designs and configurations, anode and cathode materials, as well as electrolyte salts, solvents and other battery or electrode components (e.g., separator membranes, current collectors), which can be used in the electrolytes, cells and batteries described herein, are well known in the secondary battery art, e.g., as described in “Lithium Batteries Science and Technology” Gholam-Abbas Nazri and Gianfranco Pistoia, Eds., Springer Science+Business Media, LLC; New York, NY (2009), which is incorporated herein by reference in its entirety.

The separator component of the lithium-ion cell can be any separator used in the lithium battery art. A typical material is a porous polyalkylene material such as microporous polypropylene, microporous polyethylene, a microporous propylene-ethylene copolymer, or a combination thereof, e.g., a separator with layers of different polyalkylenes; a poly(vinylidene-difluoride)-polyacrylonitrile graft copolymer microporous separator; and the like. Examples of suitable separators are described in Arora et al., Chem. Rev. 2004, 104, 4419-4462, which is incorporated herein by reference in its entirety. In addition, the separator can be an ion-selective ceramic membrane such as those described in Nestler et al., AIP Conference Proceedings 1597, 155 (2014), which is incorporated herein by reference in its entirety.

Processes used for manufacturing lithium cells and batteries are well known in the art. The active electrode materials are coated on both sides of metal foil current collectors (typically copper for the anode and aluminum for the cathode) with suitable binders such as PVDF and the like to aid in adhering the active materials to the current collectors. In the cells and batteries described herein, the active cathodes comprise the materials of Formula I described herein, which optionally can be utilized with a carbon material such as graphite, and the anode active material typically is a lithium metal, carbon, and the like. Cell assembly typically is carried out on automated equipment. The first stage in the assembly process is to sandwich a separator between the anode and the cathode. The cells can be constructed in a stacked structure for use in prismatic cells, or a spiral wound structure for use in cylindrical cells. The electrodes are connected to terminals and the resulting sub-assembly is inserted into a casing, which is then sealed, leaving an opening for filling the electrolyte into the cell. Next, the cell is filled with the electrolyte and sealed under moisture-free conditions.

Once the cell assembly is completed, the cell typically is subjected to at least one controlled charge/discharge cycle to activate the electrode materials and in some cases form a solid electrolyte interface (SEI) layer on the anode. This is known as formation cycling. The formation cycling process is well known in the battery art and involves initially charging with a low voltage (e.g., substantially lower that the full-cell voltage) and gradually building up the voltage. The SEI acts as a passivating layer which is essential for moderating the charging process under normal use. The formation cycling can be carried out, for example, according to the procedure described in Long et al. J. Electrochem. Soc., 2016; 163 (14): A2999-A3009, which is incorporated herein by reference in its entirety. This procedure involves a 1.5 V tap charge for 15 minutes at C/3 current limit, followed by a 6-hour rest period, and then 4 cycles at C/10 current limit, with a current cutoff (i≤0.05 C) at the top of each charge.

Cathodes comprising the cathode materials of Formula I described herein can be utilized with any combination of anode and electrolyte in any type of rechargeable battery system that utilizes a non-aqueous electrolyte.

The following Examples are provided to illustrate certain features of the materials, electrodes, and batteries described herein.

### Example 1. General Method for Synthesis of Materials with Lithiated Spinel Character

A mixed metal hydroxide is prepared by adding a hydroxide solution to an aqueous solution containing manganese sulfate (MnSO₄), nickel sulfate (NiSO₄) and M′ sulfate in a stoichiometry suitable to achieve targeted ratio of Ni:Mn:M′ in the final target product of Formula I. The mixed metal hydroxide is then thoroughly mixed together with a stoichiometric amount of lithium carbonate (Li₂CO₃, >99%), e.g., by grinding with a mortar and pestle or other suitable apparatus, to form a precursor mixture. The precursor mixture is then fired in air at about 400° C. to 650° C. for a period of time sufficient to achieve conversion to the target product of Formula I (e.g., approximately 72 hours). The heating rate preferably is about 2° C. per minute. The resulting material of Formula I is cooled in the furnace without controlling the cooling rate. X-ray diffraction (XRD) patterns are used to verify the structure of the product. A slight excess of Li₂CO₃ may be necessary in some instances to achieve the target composition of Formula I, e.g., if some of the lithium volatizes during firing.

The following non-limiting examples of lithiated spinel materials of Formula I can include:
Li₂Ni_{1.34}Mn_{0.66}O₄ (2.03:1 Ni:Mn);
Li₂Ni_{1.44}Mn_{0.56}O₄ (2.57:1 Ni:Mn); Li₂Ni_{1.5}Mn_{0.5}O₄ (3:1 Ni:Mn)
Li₂Ni_{1.6}Mn_{0.4}O₄ (4:1 Ni:Mn);
Li₂Ni_{1.7}Mn_{0.30}O₄ (5.66:1 Ni:Mn);
Li₂Ni_{1.8}Mn_{0.2}O₄ (9:1 Ni:Mn);
Li₂Ni_{1.33}Mn_{0.6}Al_{0.07}O₄ (2.22:1 Ni:Mn);
Li₂Ni_{1.5}Mn_{0.45}Al_{0.05}O₄ (3.33:1 Ni:Mn);
Li₂Ni_{1.5}Mn_{0.45}Co_{0.05}O₄ (3.33:1 Ni:Mn); and
Li₂Ni_{1.6}Mn_{0.18}Co_{0.22}O₄ (8.89:1 Ni:Mn).

### Example 2. Electrochemical Evaluation of Materials with Lithiated Spinel Character

Typically, electrode laminates can be prepared as follows: a slurry comprising the lithiated spinel of Formula I (e.g. 70 to 85 wt %), conductive carbon (e.g., TIMCAL SUPER C45; 5 to 15 wt %), and a binder (e.g., PVDF; 5 to 15 wt %) suspended in a polar aprotic solvent, such as NMP, is draw-coated on Al foil (e.g., 20 μm) using a suitably gapped (e.g., 200 μm) doctor blade. The laminate is then placed in an oven to remove excess solvent (e.g., at 30° C.) followed by vacuum-drying (e.g., for >8 h at 80° C.). The laminate is then punched into discs (e.g., 14 mm diameter) and each disc is paired with a Li disc (e.g., 15 mm diameter Li disc), a polyolefin separator disc (e.g., 16 mm diameter) and an electrolyte (e.g., 20 μL 1.2 M LiPF₆ in 3/7 wt/wt EC/EMC electrolyte (e.g., TOMIYAMA A49), and sealed in a cell housing (e.g., a 2032-format coin cell housing) under an inert atmosphere (e.g., in an argon-filled glove box, (<5 ppm O₂ and H₂O) for testing. Following assembly, the cells are placed in a 30° C. oven for two hours prior to electrochemical testing. Thereafter, the coin cells are charged and discharged galvanostatically, for example, between 1.5 and 5.0 V at a constant current rate of approximately 20 mA/g. Electrochemical experiments are conducted at about 30° C.

### Example 3. Synthesis and Evaluation of Li₂Ni_{1.44}Mn_{0.56}O₄ (LiNi_{0.72}Mn_{0.28}O₂ with Ni:Mn=2.57:1)

### Synthesis

A Ni_{0.72}Mn_{0.28}(OH)₂ precursor was first prepared by a co-precipitation reaction in an aqueous solution containing manganese sulfate (MnSO₄) and nickel sulfate (NiSO₄) to form a Ni_{0.72}Mn_{0.28}(OH)₂ precursor. A LiNi_{0.72}Mn_{0.28}O₂ (Li₂Ni_{1.44}Mn_{0.56}O₄) electrode material was subsequently synthesized by a relatively low-temperature solid-state reaction of the Ni_{0.72}Mn_{0.28}(OH)₂ precursor and lithium hydroxide monohydrate (LiOH·H₂O, >99%). Stoichiometric amounts of the Ni_{0.72}Mn_{0.28}(OH)₂ and LiOH·H₂O were thoroughly mixed using a mortar and pestle and fired in air at 400° C. for approximately 72 hours. The heating rate was about 2° C. per min, and the samples were cooled in the furnace without controlling the cooling rate.

### X-Ray Diffraction (XRD) Analysis

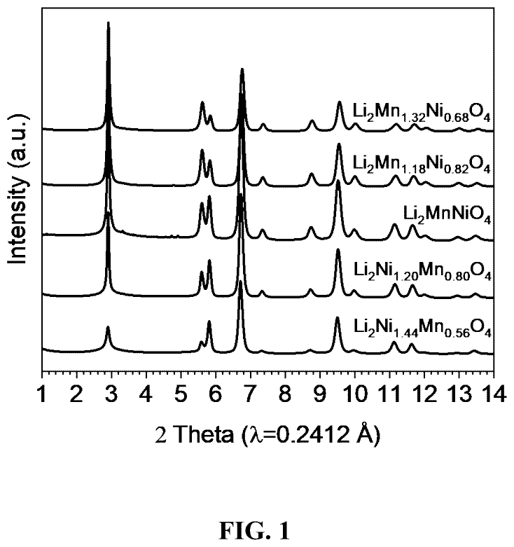

The powder XRD pattern of Li₂Ni_{1.44}Mn_{0.56}O₄ (Ni:Mn=2.57:1) as prepared above, is shown in FIG. 1, alongside the patterns of 4 other compositions, for comparison, with formulae Li₂Ni_{1.20}Mn_{0.80}O₄ (Ni:Mn=1.5:1), Li₂NiMnO₄ (Ni:Mn=1:1), Li₂Ni_{0.82}Mn_{1.18}O₄ (Ni:Mn=0.69:1) and Li₂Ni_{0.68}Mn_{1.32}O₄ (Ni:Mn=0.51:1), which have lithiated spinel-like and disordered-layered-type character. These data were collected at the Advanced Photon Source at Argonne National Laboratory. It is clear from the XRD patterns that the ‘a’ lattice parameters of these cubic lithium-nickel-manganese-oxide structures are essentially the same, despite their wide range of composition. However, the relatively low-intensity diffraction peak of the high nickel content product, Li₂Ni_{1.44}Mn_{0.56}O₄, at approximately 3° 2θ, signifies a product with a strongly disordered rock salt structure, which can stabilize layered-type and spinel-type composite lithium-metal-oxide electrode structures useful as electrode materials for lithium-ion battery applications.

### Electrochemical Analysis

Li/Li₂Ni_{1.44}Mn_{0.56}O₄ cells were assembled and evaluated as follows: Coin-type cells (2032, Hohsen) were assembled in an argon-filled glovebox (<5 ppm O₂ and H₂O) for the electrochemical tests. The cathode consisted of approximately 84 wt % of Li₂Ni_{1.44}Mn_{0.56}O₄ powder, 8 wt % carbon, and 8 wt % polyvinylidene difluoride (PVDF) binder on an aluminum foil current collector. The anode was metallic lithium foil. The electrolyte was 1.2 M lithium hexafluorophosphate (LiPF₆) in a 3:7 mixture of ethylene carbonate and ethyl methyl carbonate. The coin cell was galvanostatically charged and discharged between 1.5 and 5.0 V at a constant current of approximately 20 mA/g. Electrochemical experiments were conducted at about 30° C.

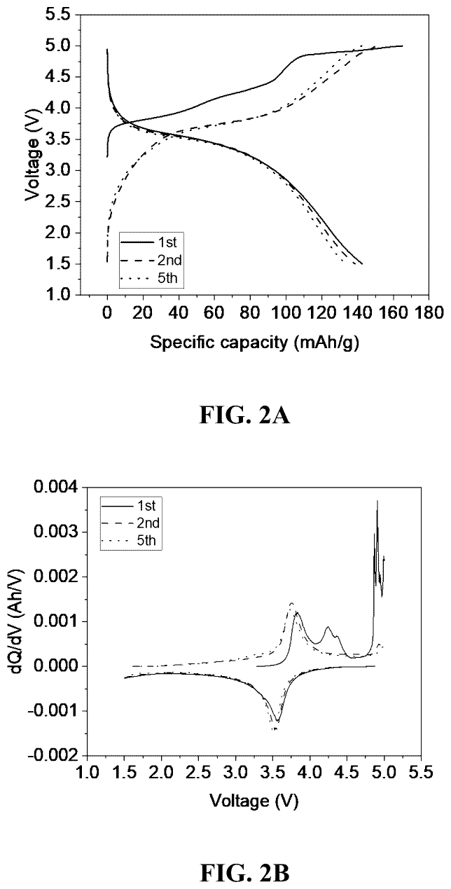

The electrochemical profiles of a Li/Li₂Ni_{1.44}Mn_{0.56}O₄ for the initial, second and fifth cycles are shown in FIG. 2A, and the corresponding dQ/dV plots in FIG. 2B. The initial charge reaction to 5.0 V has three distinct steps which can be attributed to: (1) lithium extraction from octahedral sites of the Li₂Ni_{1.44}Mn_{0.56}O₄ structure (about 3.5 to about 4.0 V); (2) lithium extraction from tetrahedral sites of a spinel-related component structure (about 4.0 to about 4.5 V); and (3) irreversible oxygen loss and electrolyte oxidation. The dQ/dV plot in FIG. 2B indicates that the second step is irreversible, suggesting that there is cation mobility, notably nickel-ion mobility during the initial charging process, and that the electrode functions thereafter primarily as a disordered rock salt structure with lithium insertion and extraction occurring predominantly into, and from, octahedral sites during discharge and charge, respectively, in a monotonic process.

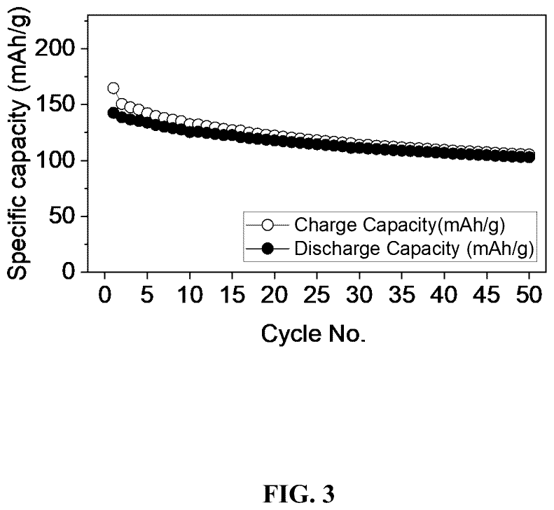

FIG. 3 shows plots of charge and discharge specific capacity versus cycle number for a Li/Li₂Ni_{1.44}Mn_{0.56}O₄ cell.

### Electrochemical Cells and Batteries

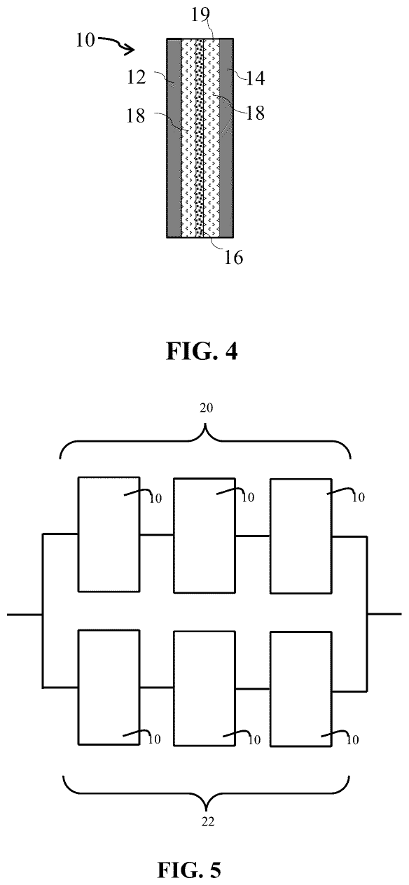

FIG. 4 schematically illustrates a cross-sectional view of a lithium-ion electrochemical cell 10 comprising first electrode 12 comprising a material of Formula I as described herein, and a second electrode 14, with separator 16 therebetween. A lithium-containing electrolyte 18 (e.g., comprising a solution of a lithium salt in a non-aqueous solvent) contacts electrodes 12 and 14 and separator 16. The electrodes, separator and electrolyte are sealed within housing 19. FIG. 5 schematically illustrates a lithium-ion battery comprising a first array 20 consisting of three series-connected electrochemical cells 10, and a second array 22 consisting of three series-connected electrochemical cells 10, in which first array 20 is electrically connected to second array 22 in parallel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electrode active material with lithiated spinel character having the general empirical formula Li₂Ni_{2-x-y}MnₓM′_{y}O₄ (Formula I); wherein M′ comprises ions of one or more metal ions other than Ni and Mn ions; 0<x≤0.66; 0≤y≤0.25; 0<(x+y)<1; and the material has a Ni:Mn molar ratio that is greater than 2:1.

2. The electrode active material of claim 1, wherein M′ comprises one or more transition metal ions.

3. The electrode active material of claim 2, wherein the transition metal ion is selected from the group consisting of Co, Ti, V, Fe, Cu and Zr.

4. The electrode active material of claim 1, wherein M′ comprises ions of one or more non-transition metal ions.

5. The electrode active material of claim 4, wherein the non-transition metal ion is selected from the group consisting of Al and Mg ions.

6. The electrode active material of claim 1, wherein M′ comprises ions of one or more non-transition metal ion and one or more transition metal ion.

7. The electrode active material of claim 1, wherein M′ comprises Co.

8. The electrode active material of claim 1, wherein M′ comprises Al.

9. The electrode active material of claim 1, wherein M′ comprises Co and Al.

10. The electrode active material of claim 1, wherein 0<x<0.5.

11. The electrode active material of claim 1, wherein 0<y≤0.1.

12. The electrode active material of claim 1, wherein 0<x<0.5 and 0<y≤0.1.

13. The electrode active material of claim 1, wherein the Ni:Mn molar ratio is in the range of about 2.01:1 to about 9:1.

14. The electrode active material of claim 1, wherein the Ni:Mn molar ratio is about 3:1 or greater.

15. The electrode active material of claim 1, wherein the Ni:Mn molar ratio is about 5:1 or greater.

16. The electrode active material of claim 1 structurally integrated with a layered-layered lithium metal oxide of general formula nLi₂MnO₃·(1−n)LiM″O₂; wherein M″ comprises ions of one or more metal, at least one of which is selected from the group consisting of Mn, Ni, and Co; and 0<n<1.

17. The electrode active material of claim 1, wherein up to 5 mol % of the oxygen thereof is replaced by fluorine.

18. The electrode active material of claim 1, wherein the metal ions of the material of Formula I are partially disordered relative to an ideal lithiated spinel structure.

19. The electrode active material of claim 1, wherein the material comprises structurally-intergrown Ni-rich components consisting of partially-disordered lithiated spinel components, partially-disordered layered components and, optionally, more extensively disordered rock-salt components.

20. An electrochemical cell comprising an anode, a cathode, and a lithium-containing electrolyte contacting the anode and cathode, wherein the cathode comprises the electrode active material of claim 1.

21. A battery comprising a plurality of the electrochemical cell of claim 20 electrically connected in series, in parallel, or in both series and parallel.
